(19) United States
(12) Patent Application Publication
(10) Pub. No.: US 2019/0005247 A1
(43) Pub. Date: Jan. 3, 2019

(54) CONTENT PROTECTION METHOD

(71) Applicant: SAMSUNG SDS CO., LTD., Seoul (KR)

(72) Inventor: Jong Ju LEE, Seoul (KR)

(73) Assignee: SAMSUNG SDS CO., LTD., Seoul (KR)

(21) Appl. No.: 16/023,578

(22) Filed: Jun. 29, 2018

(30) Foreign Application Priority Data
Jun. 30, 2017 (KR) 10-2017-0083498

(51) Int. Cl. G06F 21/60

(52) U.S. Cl. CPC G06F 21/60

(57) ABSTRACT

A method for displaying content received from a communication server on a display of a user terminal, receiving an unused terminal confirmation signal from the communication server, and shielding the content displayed on the display in response to the unused terminal confirmation signal.

This application claims the benefit of Korean Patent Application No. 10-2017-0083498, filed on Jun. 30, 2017, in the Korean Intellectual Property Office, the disclosure of which is incorporated herein by reference in its entirety.

### BACKGROUND

### 1. Field

The present disclosure relates to a content protection method, and more particularly, to a content protection method employed to prevent messages from being displayed on a messenger of a user terminal not being used by a user in an environment in which messengers installed on a plurality of user terminals are used with a single account.

### 2. Description of the Related Art

A messenger is an application that can exchange messages and data in real time with other users through a network. In the past, it was common to use a messenger by installing the messenger on a PC. However, as mobile devices such as smartphones become popularized, the use of a messenger application through a terminal such as a smartphone is rapidly increasing.

With this change in usage environment, users are increasingly installing a messenger application on a plurality of terminals and using a messenger with one account.

In this case, a message input or received by a user is displayed in synchronization on a messenger of a user terminal being used by the user and on a messenger of a user terminal not being used by the user from among a plurality of user terminals having messengers.

For example, if a messenger is installed on a PC as a first device and on a smartphone as a second device, when a user inputs a message to the messenger installed on the smartphone, the message input by the user is also displayed on the messenger of the PC currently not being used by the user. Here, if the user is located far away from the PC, the message input through the smartphone can be exposed to other people.

Therefore, there is a need for a content protection method that can prevent a message input by a user from being exposed to other people in a messenger use environment using a plurality of devices.

### SUMMARY

Aspects of the present disclosure provide a content protection method employed to prevent messages from being exposed to other people through a terminal not being used by a user in a messenger use environment using a plurality of terminals.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided a content protection method, the method including displaying content received from a communication server on a display of a user terminal; receiving an unused terminal confirmation signal from the communication server; and shielding the content displayed on the display based on the unused terminal confirmation signal being received.

The method may include receiving a preset selection input from a user; re-displaying the shielded content based on the preset selection input being received; and sending an unused terminal release signal to the communication server.

The method may include re-shielding the re-displayed content based on the preset selection input being released.

The method may include re-shielding the re-displayed content based on a preset time elapsing after the preset selection input is received.

The receiving the preset selection input may include determining that the preset selection input has been received based on one from among a text input signal, an application execution signal, and any input signal through a user interface being received.

The receiving the preset selection input from the user may include receiving a selection input for part of the content from among the shielded content, and the re-displaying the shielded content may include re-displaying the part of the content for which the selection input has been received.

The method may include re-shielding the re-displayed content based on the selection input for the content being released.

The shielding the content displayed on the display may include converting an entirety of a chat window area, in which the content is displayed, into an image having a preset pattern, and displaying the image.

The method may include receiving a selection input for a point in the chat window area; and re-displaying content included in an area having a preset radius around the point in the chat window area where the selection input has been received.

The shielding the content displayed on the display may include shielding only content that contains a preset text.

The shielding the content displayed on the display may include shielding only content set as security content.

The shielding the content displayed on the display may include converting text contained in the content into an image of a preset pattern and displaying the image.

The shielding the content displayed on the display may include shielding new content displayed on a notification pop-up window when the new content is received from the communication server.

According to an aspect of the present disclosure, there is provided an apparatus for protecting a content, including; a hardware processor; a memory configured to store a computer program; and wherein the computer program includes one or more instructions which, when executed by the hardware processor, causes the apparatus to: display content received from a communication server on a display of a user terminal; receive an unused terminal confirmation signal from the communication server; and shield the content displayed on the display based on the unused terminal confirmation signal being received.

According to an aspect of the present disclosure, there is provided a non-transitory computer-readable storage medium for storing a computer program including one or more instructions which, when executed by a computing apparatus, causes the computing apparatus to: display content received from a communication server on a display of a user terminal; receive an unused terminal confirmation signal from the communication server; and shield the content displayed on the display based on the unused terminal confirmation signal being received.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a messenger use environment using a plurality of user terminals;

FIG. 2 illustrates a content protection method according to an embodiment;

FIG. 3 illustrates a case where messages are displayed to be shielded on an unused terminal according to an embodiment;

FIG. 4 illustrates a case where messages are displayed to be shielded on an unused terminal according to an embodiment;

FIG. 5 illustrates a case where only some messages are shielded according to an embodiment;

FIG. 6 illustrates a process of setting a security message according to an embodiment;

FIG. 7 illustrates a process in which a user terminal that has received an unused terminal confirmation signal shields a message set as a security message according to an embodiment;

FIG. 8 illustrates a process of re-displaying shielded messages according to an embodiment;

FIG. 9 illustrates a process of displaying shielded messages according to an embodiment;

FIG. 10 illustrates a process of displaying shielded messages according to an embodiment;

FIG. 11 illustrates a process of re-displaying only some of the shielded messages according to an embodiment;

FIG. 12 illustrates a process of re-displaying a message selected from among shielded messages according to an embodiment;

FIG. 13 illustrates a process of re-shielding a message whose selection input has been released according to an embodiment;

FIG. 14 illustrates a process of re-displaying a chat room when the entire chat room is shielded according to an embodiment;

FIG. 15 illustrates a case where only a part of a shielded chat room is displayed again according to an embodiment;

FIG. 16 illustrates a method of shielding a new message displayed on a notification pop-up window according to an embodiment; and

FIG. 17 illustrates a method of shielding a new message displayed on a notification pop-up window according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described in detail with reference to the accompanying drawings.

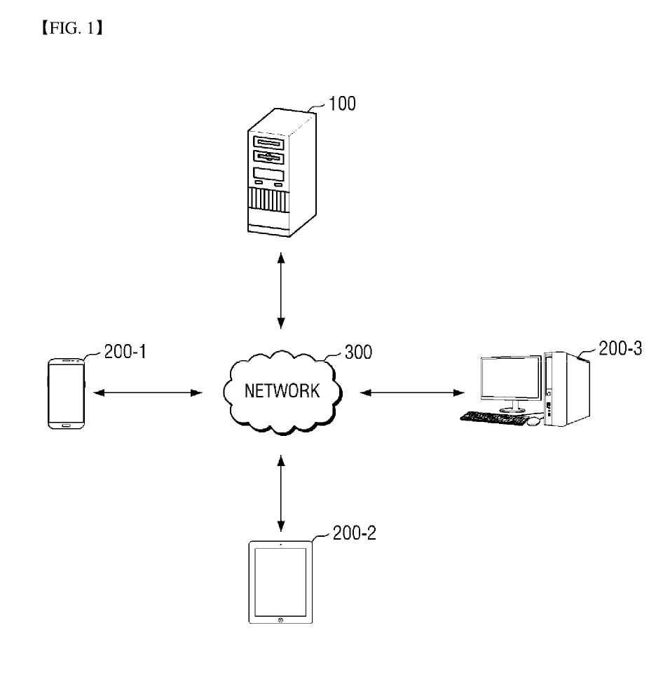

FIG. 1 illustrates a messenger use environment using a plurality of user terminals.

In FIG. 1, a smartphone 200-1, a tablet PC 200-2 and a desktop PC 200-3 are illustrated as the user terminals. However, the user terminals on which a messenger can be installed are limited to these examples and can also be other general-purpose electronic devices.

For example, a case where a messenger is installed on a plurality of PCs and messages are used with one messenger account, a case where a messenger is installed on a PC and a mobile device and messages are used with one messenger account, or a case where a messenger is installed on a plurality of mobile devices and messages are used with one messenger account may correspond to the messenger use environment described herein.

Alternatively, a case where a messenger is installed on a physical device and a virtual device may correspond to the messenger use environment.

A user may install a messenger application on his or her user terminals (200-1, 200-2 and 200-3) and exchange messages or data with other users through the messenger application.

Here, the user may connect to the messenger application installed on the different user terminals (200-1, 200-2 and 200-3) using one account.

Messages input by the user are sent to a user terminal of another user through a messenger server 100. At this time, the messages input by the user are also sent to the user's other user terminals having the messenger, so that the content of the conversation can be synchronized.

For example, when the user sends a message to another user using the smartphone 200-1, the messenger server 100 sends the message input by the user not only to a user terminal of the another user, but also to the tablet PC 200-2 and the desktop PC 200-3 used by the user who input the message.

When receiving a message from another user, the messenger server 100 also sends the received message to the messenger installed on each user terminal of the user so as to synchronize the content of the conversation.

Therefore, even if the user changes to the desktop PC 200-3 while sending and receiving messages using the smartphone 200-1, he or she can still continue the conversation seamlessly.

A method of protecting messages in a messenger use environment using a plurality of user terminals will now be described in detail.

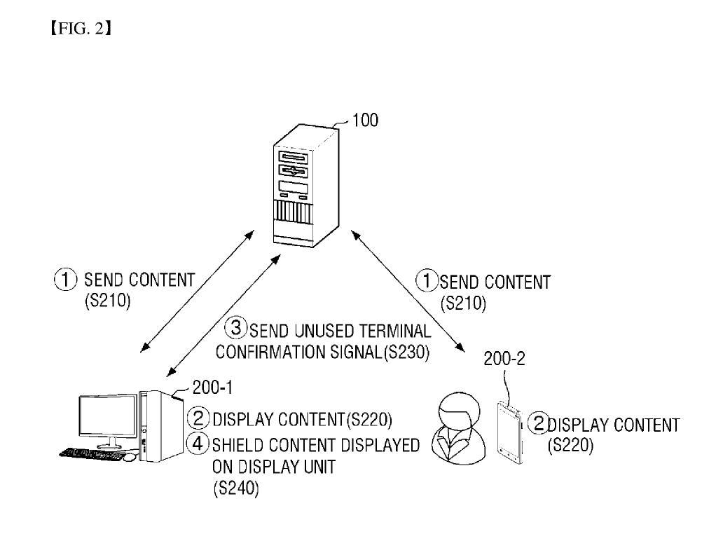

FIG. 2 illustrates a content protection method according to an embodiment.

A content protection system according to an embodiment includes a communication server and a plurality of user terminals.

Each of the user terminals is provided with an application capable of exchanging content among users. The content according an embodiment may include text, images, and data files. Here, each application may be accessed using one user account.

For ease of description, a case where the application installed on each of the user terminals is a messenger application and the communication server is a messenger server 100 will hereinafter be described as an example. In addition, a case where the content exchanged among users is messages will be described as an example.

However, the type of application that can be installed on each user terminal and the content exchanged among the users are not limited to the above example.

The messenger server 100 sends a message input by another user to a first user terminal 200-1 and a second user terminal 200-2 (operation S210).

Then, each of the first user terminal 200-1 and the second user terminal 200-2 displays the received message on a display unit (operation S220). Here, each of the first user terminal 200-1 and the second user terminal 200-2 may display not only the message sent from the another user but also a message directly input by a user.

In this case, if a message input through the second user terminal 200-2 is sent to the messenger server 100 and the messenger server 100 sends the message to the first user terminal 200-1, the message directly input by the user is also displayed on the first user terminal 200-1.

Next, the messenger server 100 identifies an unused terminal and sends an unused terminal confirmation signal (operation S230). Here, the unused terminal refers to a user terminal which has the messenger application and thus displays sent/received messages in synchronization with other user terminals but is not currently being used by the user.

The messenger server 100 according to an embodiment may identify a user terminal other than a user terminal, from which a message was last sent by the user, as an unused terminal.

In the current embodiment, since a message input by the user through the second terminal 200-2 will be sent, the first terminal 200-1 may be identified as an unused terminal.

A user terminal which receives the unused terminal confirmation signal shields the message displayed on the display unit (operation S240). Here, “shielding the displayed message” means that text contained in the message is made not to be displayed.

Therefore, putting an image on top of the text contained in the message to hide the text or converting the text contained in the message into an image and displaying the image may all correspond to shielding the message.

According to an embodiment, the text contained in the message may be made not to be displayed by converting the text contained in the message into an image of a preset pattern or displaying the entire chat window as a certain image.

In the current embodiment, a case where a message displayed on the messenger application is shielded has been described. However, the content protection method according to the present disclosure can also be applied to various forms of applications that can connect to a plurality of user terminals with one account.

Examples of such applications include an email application that can send and receive messages or content in real time and a remote control application that can control remote user terminals using one user terminal.

A process in which a user terminal identified as an unused terminal shields messages will now be described.

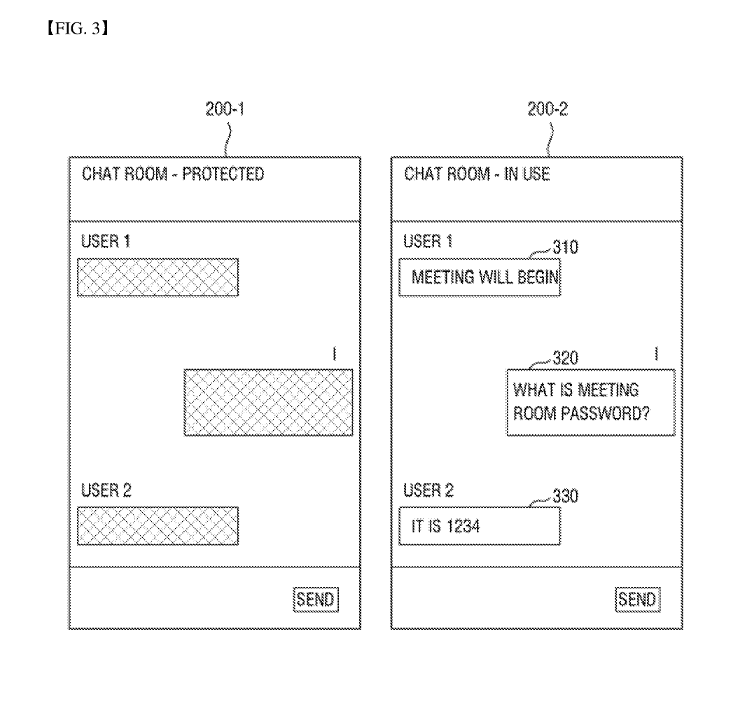

FIG. 3 illustrates a case where messages are displayed to be shielded on an unused terminal according to an embodiment.

The screen illustrated in FIG. 3 is a messenger chat window displayed on all or part of the display unit of each of the first user terminal 200-1 and the second user terminal 200-2.

If a user is using a messenger through the second user terminal 200-2, he or she will input messages through the second user terminal 200-2. Therefore, a message 320 last input by the user is a message input through the second user terminal 200-2.

On the other hand, since the first user terminal 200-1 is not being used by the user, there is no message input through the first user terminal 200-1.

Therefore, the messenger server 100 may determine the first user terminal 200-1 other than the second user terminal 200-2 to which a message was last input as an unused terminal.

Messages sent from the messenger server 100 are displayed to be shielded on the first user terminal 200-1. To shield a received message, a user terminal according to an embodiment may convert an area where text is displayed into an image of a preset pattern and display the image.

Alternatively, an image may be put on top of the area where the text is displayed in order to hide the text contained in the message.

In the current embodiment, a case where only a text area included in a message is shielded in a chat window area has been described. However, a message can also be shielded in other ways.

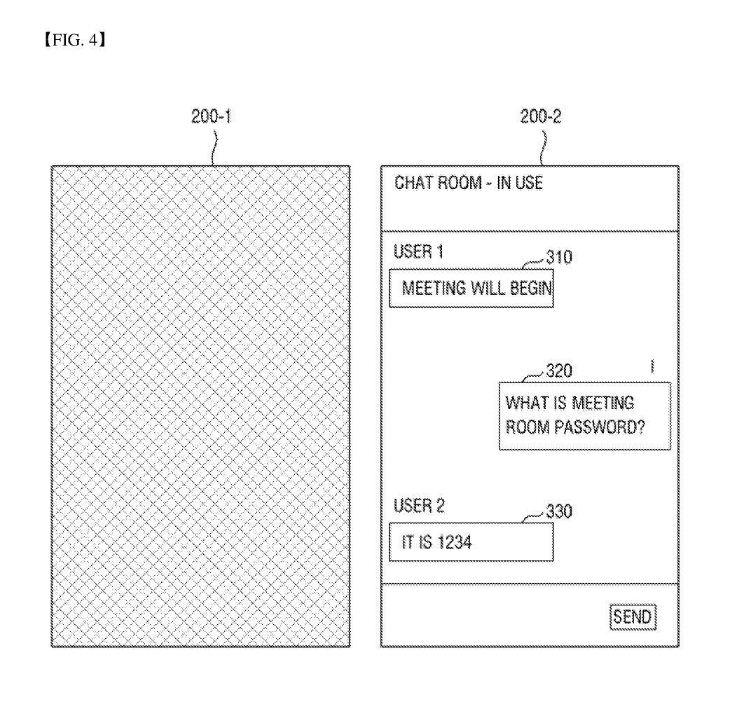

FIG. 4 illustrates a case where messages are displayed to be shielded on an unused terminal according to an embodiment.

When receiving the unused terminal confirmation signal from the messenger server 100, the first user terminal 200-1 may shield messages by converting the entire chat window area in which the messages are displayed into an image having a preset pattern.

In order to exchange messages with other users using a messenger, a user opens a chat room in which at least one user participates and then sends and receives messages in the chat room.

Here, the entire chat room is converted into an image of a preset pattern in order to prevent text contained in the messages from being exposed.

In the above-described embodiments, a case where all of the sent/received messages are shielded has been described. However, only certain messages can be shielded.

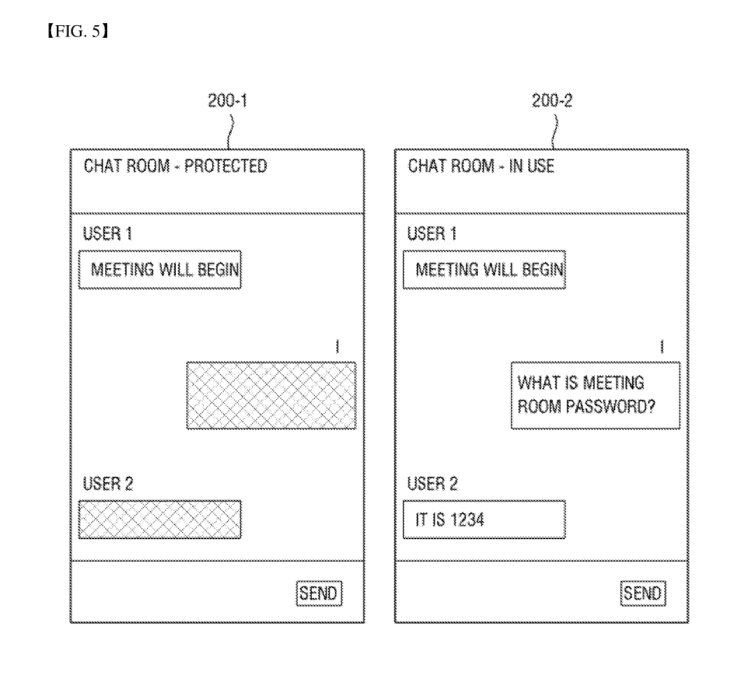

FIG. 5 illustrates a case where only some messages are shielded according to an embodiment.

Since not all messages exchanged among users require high security, it may be possible to maintain security even when only certain messages are shielded.

To this end, in the content protection method according to the embodiment, only messages containing a preset text may be shielded. If a user inputs a specific text to a messenger, a user terminal receiving the unused terminal confirmation signal from the messenger server 100 shields messages containing the preset text from among received messages.

For example, the user may set messages containing the text “secret” to be shielded. In FIG. 5, since the second user terminal 200-2 is currently being used by the user, messages input by the user and messages received from other users are all displayed on the second user terminal 200-2.

On the other hand, the first user terminal 200-1 which has received the unused terminal confirmation signal from the messenger server 100 shields messages containing a text preset by the user, that is, the text “secret” from among messages received from the messenger server 100.

In an embodiment, when sending messages, the user may set a message requiring security as a security message, so that only the message set as the security message is shielded.

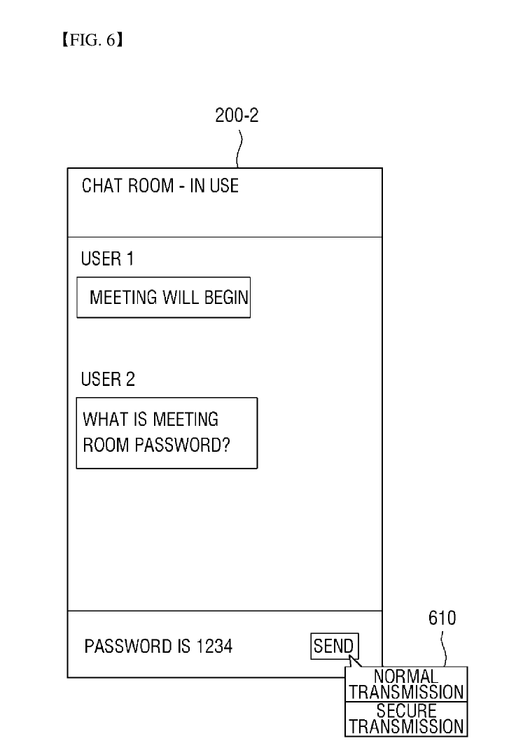

FIG. 6 illustrates a process of setting a security message according to an embodiment.

When a user selects a send button after inputting text to the second user terminal 200-2 currently being used, a function menu 610 for setting a message as a security message is displayed.

If the user selects “normal transmission,” a message sent by the user is also sent to the first user terminal 200-1 through the messenger server 100.

In the case of a message set as a normal message, the content of the message, that is, text contained in the message is also displayed on the first user terminal 200-1 which has received the unused terminal confirmation signal.

On the other hand, if the user selects “secure transmission” in the function menu 610, the content of the text input by the user and a security setting identifier are sent together to the messenger server 100.

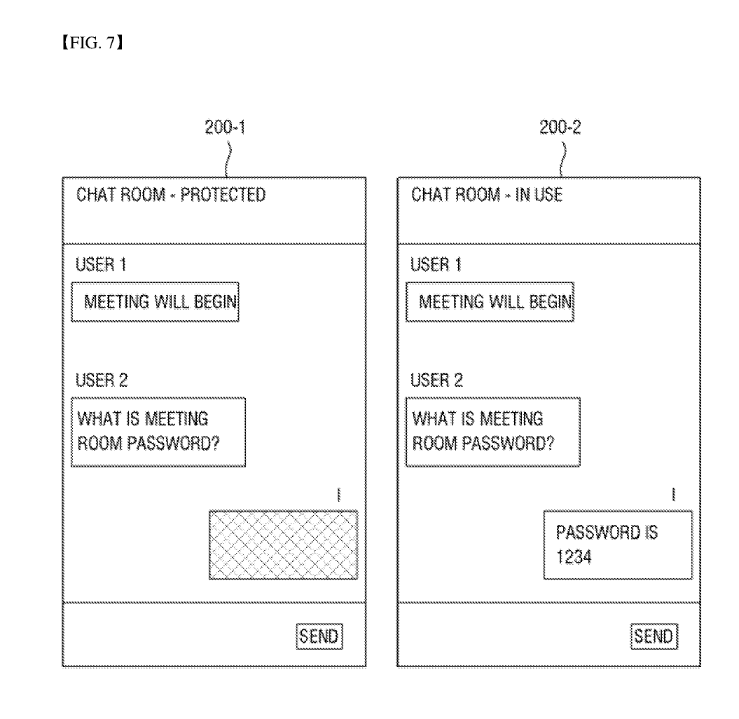

FIG. 7 illustrates a process in which a user terminal that has received the unused terminal confirmation signal shields a message set as a security message according to an embodiment.

The first terminal 200-1 which has received the unused terminal confirmation signal displays a general message without shielding text contained in the general message.

On the other hand, text contained in a security message is shielded. Specifically, the first user terminal 200-1 which has received the unused terminal confirmation signal from the messenger server 100 recognizes a message containing a security setting identifier as a security message from among messages received from the messenger server 100 and shields the security message.

Meanwhile, if it is determined that a user terminal which has received the unused terminal confirmation signal from the messenger server 100 is being used again by the user, shielded messages are displayed again.

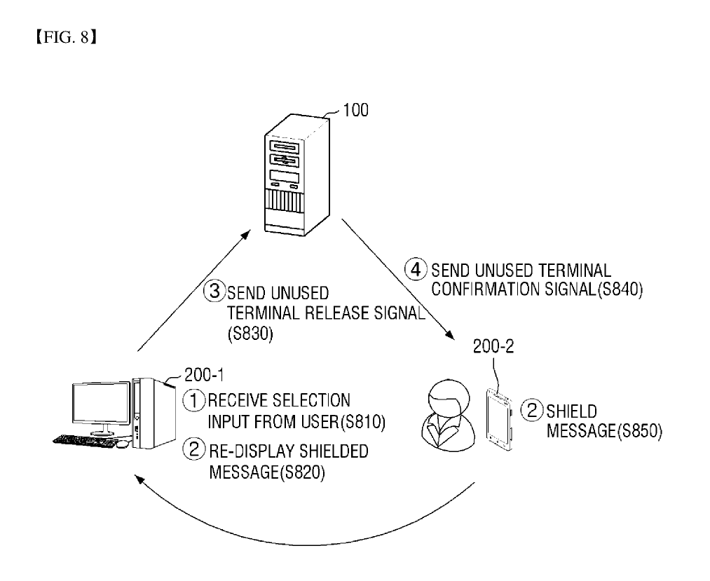

FIG. 8 illustrates a process of re-displaying shielded messages according to an embodiment.

There may be cases where a user using a messenger through the second user terminal 200-2 changes to the first user terminal 200-1.

For example, a user using a messenger through a smartphone outside an office may return to the office and use the messenger through a desktop PC.

In this case, the first user terminal 200-1 shielding messages received from the messenger server 100 in response to the unused terminal confirmation signal receives a preset selection input from the user (operation S810).

The preset selection input according to an embodiment may be one of a text input signal, a messenger application execution signal, and any input signal through a user interface.

The preset selection input will be described in detail below.

When the preset selection input is received, the shielded messages are re-displayed (operation S820).

The re-displaying of the shielded messages may be to remove an image having a preset pattern if the image is put on top of text contained in the messages or restoring the original text if the text contained in the messages has been converted into an image.

That is, messages received from the messenger server 100 are displayed as they are, so that the user can view the content of the messages.

Next, the first user terminal 200-1 sends an unused terminal release signal to the messenger server 100 (operation S830). The unused terminal release signal is a signal for informing the messenger server 100 that a user terminal currently being used by the user is the first user terminal 200-1.

When receiving the unused terminal release signal from the first user terminal 200-1, the messenger server 100 sends the unused terminal confirmation signal to the second user terminal 200-2 other than the first user terminal 200-1 which has sent the unused terminal release signal (operation S840).

Then, the second user terminal 200-2 shields messages received from the messenger server 100 so that text contained in the messages is not exposed (operation S850).

If messages received by the second user terminal 200-2 are shielded even though the user is currently using the second user terminal 200-2, it can be identified that another person has accessed the messenger through another user terminal.

This is because, as described above, messages of the second user terminal 200-2 are shielded when the messenger server 100 recognizes the second user terminal 200-2 as an unused terminal in response to the unused terminal release signal received from another user terminal.

Therefore, in the content protection method of the present disclosure, it is possible to identify that another user has accessed the messenger through a user terminal currently not being used by the user.

The process of re-displaying shielded messages will now be described in detail.

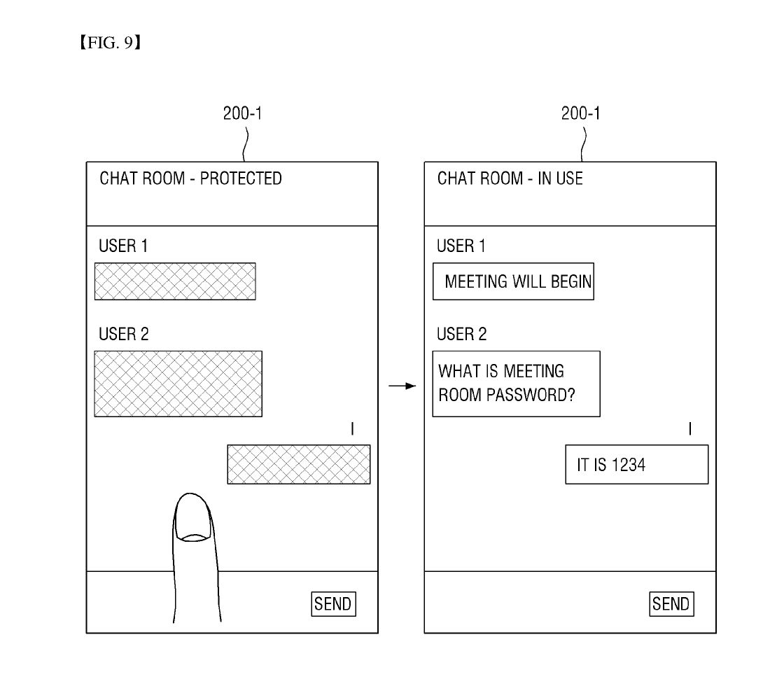

FIG. 9 illustrates a process of displaying shielded messages according to an embodiment.

When an input signal is received through a user interface while messages are being shielded, the shielded messages are displayed again.

If the first user terminal 200-1 includes a touch screen according to an embodiment, when a user's touch input is received, it is determined that the first user terminal 200-1 is being used again by the user. Therefore, the shielded messages are displayed again.

The user's selection input received through the user interface is not limited to the touch input and may also be an input received through a user interface such as a mouse or a keyboard.

For example, when the user moves a mouse cursor, clicks a mouse button, or presses a key on a keyboard, it may be determined that the user's selection input has been received. Thus, shielded messages may be displayed again.

When the shielded messages are displayed again, text contained in the messages is displayed. Therefore, the user can view the content of the messages on a user terminal he or she has changed to.

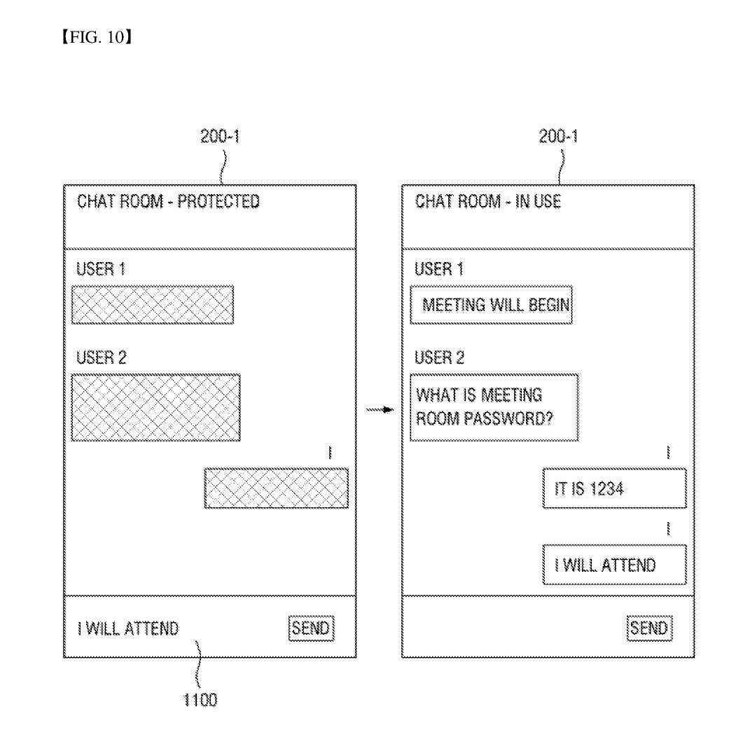

FIG. 10 illustrates a process of displaying shielded messages according to an embodiment.

When a user inputs a message to the first user terminal 200-1 which is shielding messages in response to the unused terminal confirmation signal received from the messenger server 100, the shielded messages are displayed again.

Specifically, when the use inputs a message to a message input area 1100 of a messenger chat room through a user interface such as a keyboard or a touch screen, the shielded messages may be displayed again.

Alternatively, when the user presses a send button after inputting a message to the message input area 1100, the message input by the user may be sent to the messenger server 100, and the shielded messages may be displayed again.

In FIGS. 9 and 10, shielded messages are displayed again when a user's selection input is received through a user interface or when a message is input through a user interface. However, the shielded messages can be displayed again in other ways.

For example, when a selection input for activating a messenger being executed in the back-end is received, the shielded messages may be displayed again.

In the above-described embodiments, a case where all of the shielded messages are displayed again has been described. However, only some of the shielded messages can be displayed.

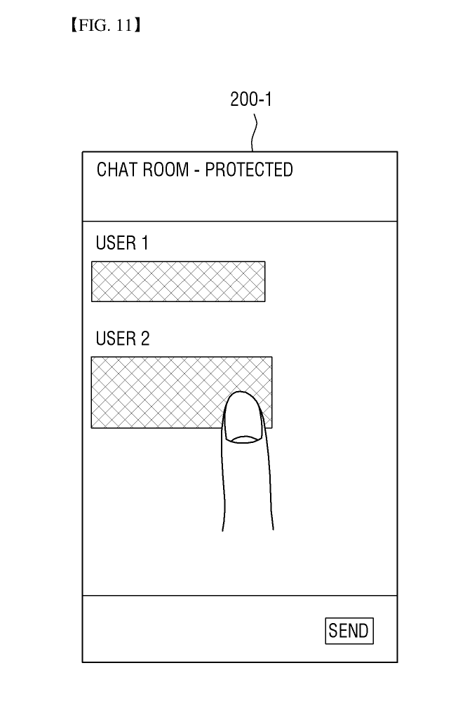

FIG. 11 illustrates a process of re-displaying only some of the shielded messages according to an embodiment.

According to an embodiment, the first user terminal 200-1 may receive a selection input for one of the shielded messages from a user.

In FIG. 11, the first user terminal 200-1 has a touch screen and receives a touch input for one of the shielded messages. However, the method of selecting a message is not limited to this method.

For example, the user may select a shielded message by placing a cursor on the shielded message using a mouse.

In addition, although a selection input for one shielded message is received in FIG. 11, selection inputs for a plurality of shielded messages can be received simultaneously.

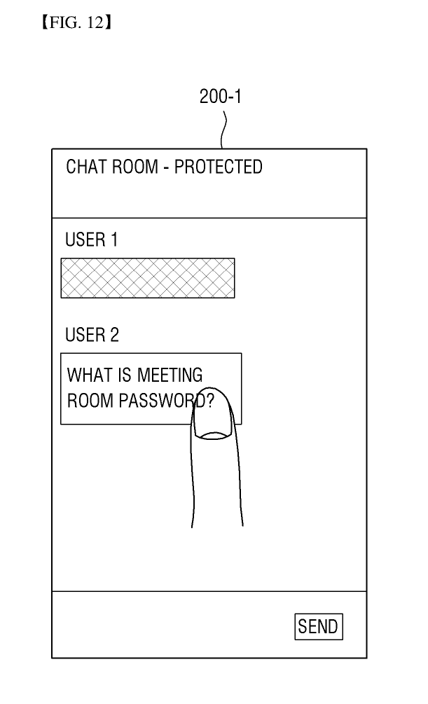

FIG. 12 illustrates a process of re-displaying a message selected from among shielded messages according to an embodiment.

When a selection input for at least one of a plurality of shielded messages is received, only the message for which the selection input has been received is displayed again. That is, messages for which selection inputs have not been received from a user remain shielded.

According to an embodiment, a shielded message may be displayed again only while a selection input is being received from the user or may be displayed again for a preset time after the user's selection input is received.

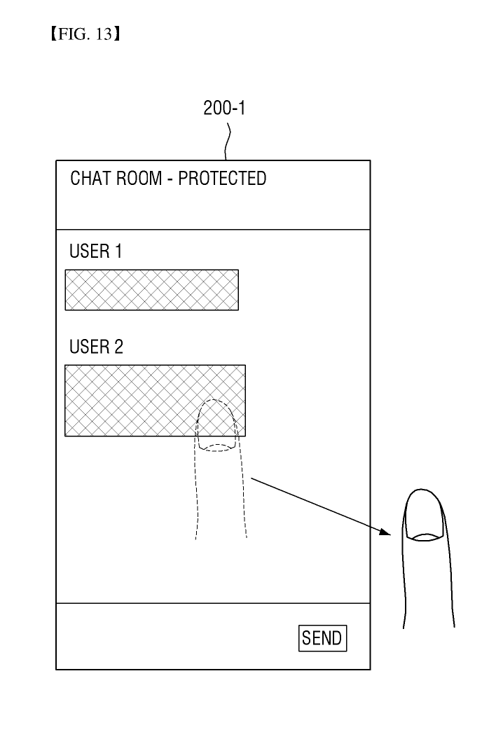

FIG. 13 illustrates a process of re-shielding a message whose selection input has been released according to an embodiment.

While a message is being displayed again in response to a user's selection input, if the selection input for that message is released, the message is shielded again.

For example, while a message is being displayed again in response to a selection input for the message, if the user stops the touch input, the temporarily displayed message is shielded again. That is, only a message for which a selection input is being received from the user is displayed again.

Alternatively, a message may be automatically shielded when a preset time elapses after the user's selection input is interrupted.

For example, when a selection input for a shielded message is received, the message may be displayed again. However, the message may be shielded again after a preset time regardless of the user's selection input.

In the above-described embodiments, only the process of re-displaying messages received from the messenger server 100 when text contained in the messages is shielded has been described. However, when the entire chat room is shielded, messages can also be displayed again in a similar way.

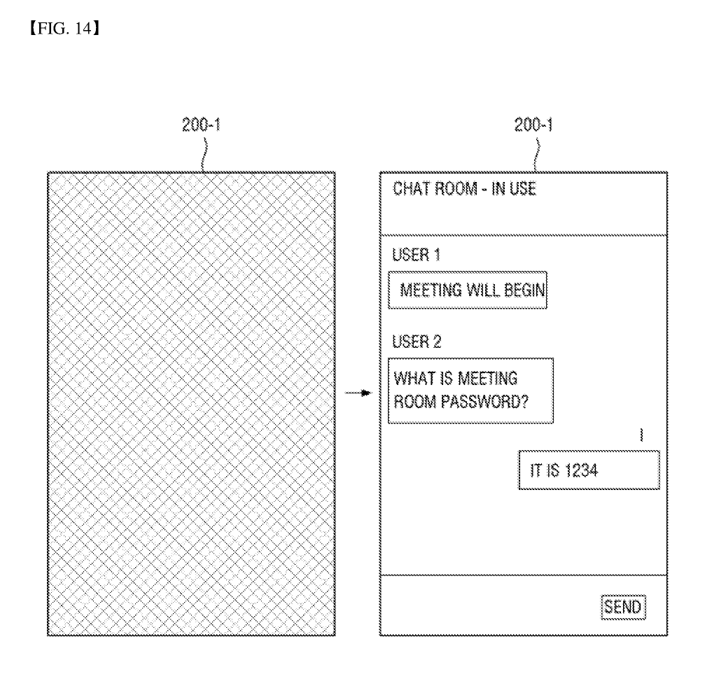

FIG. 14 illustrates a process of re-displaying a chat room when the entire chat room is shielded according to an embodiment.

According to an embodiment, when a user's selection input is received while the entire chat room is being shielded, shielded messages may be displayed again.

As described in the above example, the user's selection input may be a touch input or an input through a user interface such as a mouse or a keyboard.

The shielded messages may be displayed again while the user's selection input is being received and may be shielded again when the user's selection input is interrupted. Alternatively, the shielded messages may be displayed again from a time when the user's selection input is received and may be shielded again after a preset time elapses.

In FIG. 14, a case where the whole of a shielded chat room in which messages are displayed is displayed again in response to a user's selection input has been described as an example. However, only a part of the chat room can be displayed again.

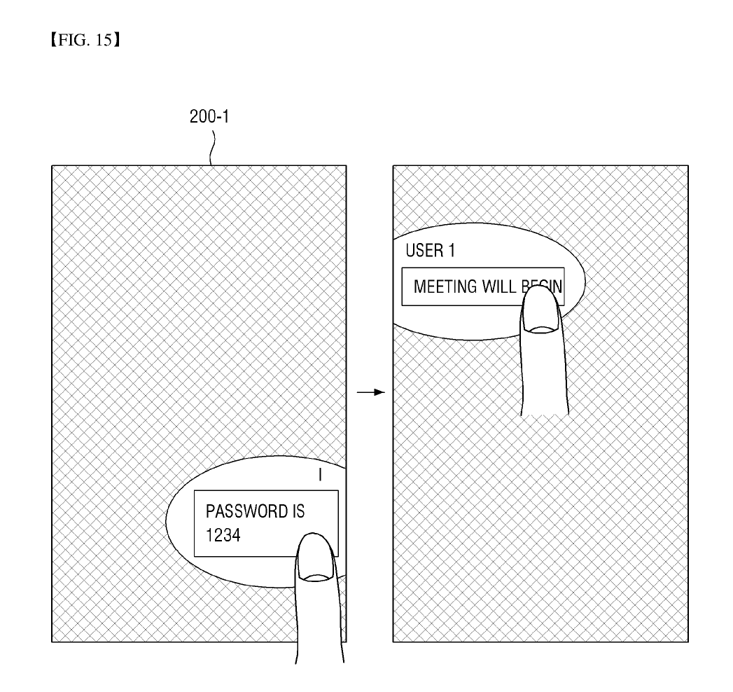

FIG. 15 illustrates a case where only a part of a shielded chat room is displayed again according to an embodiment.

When a user's selection input is received while the entire chat room in which messages are displayed is being shielded, only an area adjacent to a point where the selection input has been received may be displayed again. For example, if the user's selection input is a touch input, only a circle area having a preset radius around a point where the user's touch input has been received may be displayed again.

Alternatively, if a selection input is received through a mouse, only a circle area having a preset radius around a point where a cursor is positioned may be displayed again.

Here, if the position at which the user's selection input is received is changed, a shielded area to be displayed again may also be changed. Therefore, the user can view shielded messages by changing the input point.

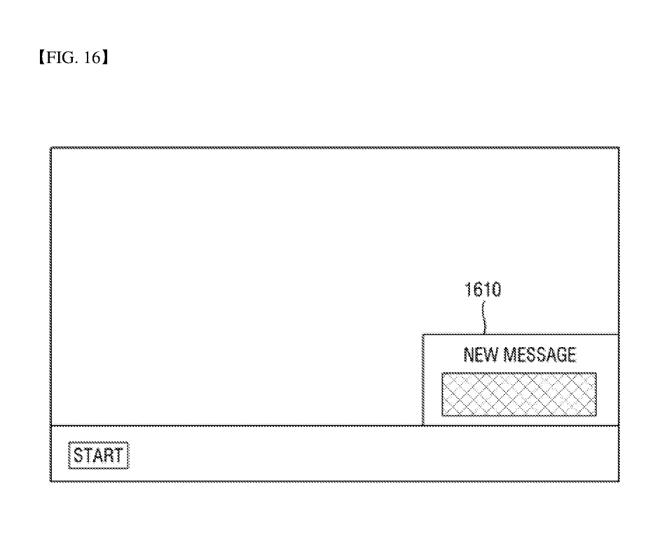

FIG. 16 illustrates a method of shielding a new message displayed on a notification pop-up window according to an embodiment.

A user may use a messenger with a messenger chat room enabled. However, there are also cases where the user uses the messenger with the chat room disabled while a messenger application works in the back-end.

Here, when a new message is received, a notification pop-up window informing the user of the reception of the new message is displayed. For example, the fact that the new message has been received and part of the content of the new message may be displayed on a part of a display unit of a user terminal.

According to an embodiment, when a user terminal which has received the unused terminal confirmation signal from the messenger server 100 receives a new message and displays a notification pop-up window 1610, the new message displayed on the notification pop-up window 1610 may be shielded.

For example, if the user terminal is a desktop PC, the notification pop-up window 1610 is displayed when a new message is received, and all or part of the text contained in the new message is displayed on the notification pop-up window 1610.

At this time, if the user terminal has received the unused terminal confirmation signal from the messenger server 100, the new message displayed on the notification pop-up window 1610 may be shielded.

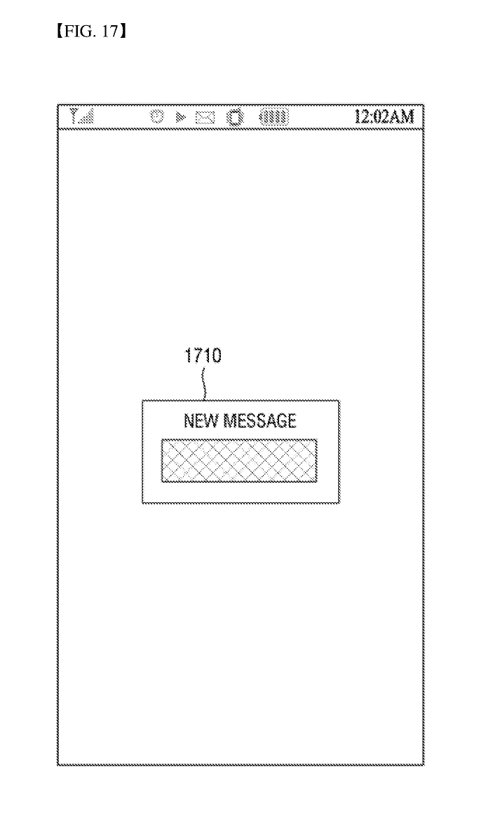

FIG. 17 illustrates a method of shielding a new message displayed on a notification pop-up window according to an embodiment.

Even when a user terminal is an electronic device such as a smartphone or a tablet PC, a new message displayed on a notification pop-up window can be shielded.

For example, when a new message arrives while a display unit of a dormant user terminal is turned off, a notification pop-up window 1710 may be displayed on a part of the screen, together with the content of the message.

Here, if the user terminal has received the unused terminal confirmation signal from the messenger server 100, the new message displayed on the notification pop-up window 1710 may be shielded to prevent the content of the message from being exposed.

In addition, when a user's selection input is received, the shielded message may be displayed again in response to the user's selection input, as described above.

According to the content protection method described above, when a messenger application is used in a plurality of user terminals, it is possible to prevent the content of the messenger from being exposed through a user terminal not being used by a user.

The concepts of the invention described above with reference to FIGS. 1 to 10D can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A content protection method comprising:
displaying content received from a communication server on a display of a user terminal;
receiving an unused terminal confirmation signal from the communication server; and
shielding the content displayed on the display based on the unused terminal confirmation signal being received.

2. The content protection method of claim 1, further comprising:
receiving a preset selection input from a user;
re-displaying the shielded content based on the preset selection input being received; and
sending an unused terminal release signal to the communication server.

3. The content protection method of claim 2, further comprising re-shielding the re-displayed content based on the preset selection input being released.

4. The content protection method claim 2, further comprising re-shielding the re-displayed content based on a preset time elapsing after the preset selection input is received.

5. The content protection method of claim 2, wherein the receiving the preset selection input comprises determining that the preset selection input has been received based on one from among a text input signal, an application execution signal, and any input signal through a user interface being received.

6. The content protection method of claim 2, wherein the receiving the preset selection input from the user comprises receiving a selection input for part of the content from among the shielded content, and the re-displaying the shielded content comprises re-displaying the part of the content for which the selection input has been received.

7. The content protection method of claim 6, further comprising re-shielding the re-displayed content based on the selection input for the content being released.

8. The content protection method of claim 1, wherein the shielding the content displayed on the display comprises converting an entirety of a chat window area, in which the content is displayed, into an image having a preset pattern, and displaying the image.

9. The content protection method of claim 8, further comprising:
receiving a selection input for a point in the chat window area; and
re-displaying content included in an area having a preset radius around the point in the chat window area where the selection input has been received.

10. The content protection method of claim 1, wherein the shielding the content displayed on the display comprises shielding only content that contains a preset text.

11. The content protection method of claim 1, wherein the shielding the content displayed on the display comprises shielding only content set as security content.

12. The content protection method of claim 1, wherein the shielding the content displayed on the display comprises converting text contained in the content into an image of a preset pattern and displaying the image.

13. The content protection method of claim 1, wherein the shielding the content displayed on the display comprises shielding new content displayed on a notification pop-up window when the new content is received from the communication server.

14. An apparatus for protecting a content, comprising;
a hardware processor;
a memory configured to store a computer program; and
wherein the computer program comprises one or more instructions which, when executed by the hardware processor, causes the apparatus to:
display content received from a communication server on a display of a user terminal;
receive an unused terminal confirmation signal from the communication server; and
shield the content displayed on the display based on the unused terminal confirmation signal being received.

15. A non-transitory computer-readable storage medium for storing a computer program comprising one or more instructions which, when executed by a computing apparatus, causes the computing apparatus to:
display content received from a communication server on a display of a user terminal;
receive an unused terminal confirmation signal from the communication server; and
shield the content displayed on the display based on the unused terminal confirmation signal being received.
